(19) United States
(12) Patent Application Publication
(10) Pub. No.: US 2009/0022568 A1
(43) Pub. Date: Jan. 22, 2009

(54) SELF-TAPPING CONCRETE SCREW

(76) Inventors: Jan-Christian Becker, Steinhagen (DE); Oliver Hacker, Horb (DE); Klaus Mayer, Messstetten (DE); Marc Schaeffer, Feldhirch (AU)

Correspondence Address: MICHAEL J. STRIKER, 103 EAST NECK ROAD, HUNTINGTON, NY, 11743, US

(21) Appl. No.: 11/911,547

(22) PCT Filed: Apr. 4, 2006
(86) PCT No.: PCT/EP06/03036

§ 371 Date: Apr. 23, 2008

(30) Foreign Application Priority Data
Apr. 16, 2005 (DE) 10 2005 017 596.1

(51) Int. Cl. F16B 25/00

(52) U.S. Cl. 411/386

(57) ABSTRACT

In order to improve the holding force of a self-tapping concrete screw (1) in a hole (2) drilled in concrete (3), the invention proposes formation of the concrete screw (1) with two threads (8, 9) having different external diameters (d₁, d₂), the spacing (p₁) of the thread (8) which has the smaller external diameter (d₁) to the thread (9) which has the larger external diameter (d₂) when seen from the front end (5) of the screw being smaller than the spacing (p₂) of the thread (9) having the larger external diameter to the thread (8) having the smaller external diameter. The threads (8, 9) are preferably sawtooth threads.

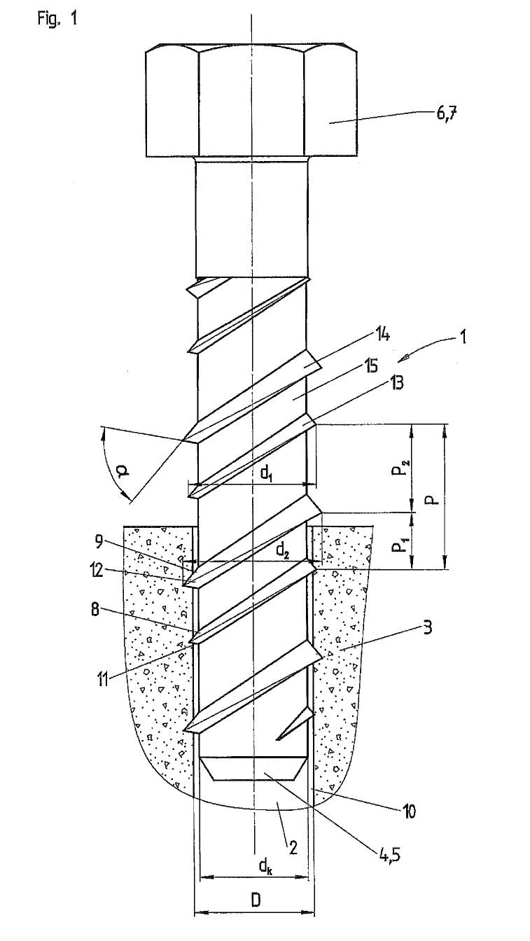

The invention relates to a self-tapping concrete screw for screwing into a hole drilled in concrete, masonry or the like.

Concrete screws are screwed without fixing plugs or the like into holes previously drilled in concrete, masonry or the like, their thread cutting into the wall of the drilled hole in the process. The core diameter of the concrete screw is smaller than the diameter of the drilled hole so that an intermediate space is formed between the core of the screw and the wall of the drilled hole. An example of a concrete screw of such a kind is disclosed in EP 623 759 B1.

The invention is based on the problem of proposing a self-tapping concrete screw which has a high holding force with an acceptable screw-in torque or screw-in energy.

The problem is solved in accordance with the invention by the features of claim 1. The concrete screw according to the invention has two threads having different external diameters and having spacings from one another that differ in the two directions along the axis of the concrete screw. Thread spacings that differ from one another means that the distance from one thread to the other thread in one direction along the axis of the concrete screw is less than in the other direction along the axis. The threads are accordingly not located in the middle between two successive turns of the respective other thread. The diameter of the drilled hole should be smaller than the external diameter of the smaller thread so that the thread having the smaller external diameter also cuts into the wall of the drilled hole and contributes to the hold of the concrete screw in the concrete.

The two threads having different external diameters transfer the force into the concrete more uniformly and in better distributed manner than a single thread and also than two threads which have the same external diameter. A further advantage is improved installation sensation for a user when screwing the concrete screw into the drilled hole; the concrete screw screws and cuts into the drilled hole better.

Also, the different spacings of the threads in the two directions of the concrete screw improve the transfer of force from the concrete screw to the concrete, the size of the thread spacings from one another being so selected that drilling dust which remains in the drilled hole after drilling and which is produced when the threads cut into the wall of the drilled hole has sufficient clear space between the threads and between the core of the concrete screw and the wall of the drilled hole.

In a preferred embodiment of the invention, the spacing of the thread having the smaller external diameter from the thread having the larger external diameter in the direction of the front end of the concrete screw is greater than in the direction of the rear end of the concrete screw. The front end of the screw is that end which is leading on screwing the concrete screw into the drilled hole. The rear end of the screw usually has a screw head and is intended for application of a driving tool or a rotary percussion tool. Seen from the thread having the larger external diameter, the thread having the smaller external diameter has a smaller spacing looking towards the front end of the screw than towards the rear end of the screw. Because force to the concrete is transferred from the concrete screw by the threads into the concrete in the direction of the rear end of the screw, the force into the concrete is transferred, at the smaller spacing in the direction of the rear end of the screw, from the thread having the smaller external diameter, which cuts less deeply into the wall of the drilled hole, from the thread having the larger external diameter and, at the larger spacing in the direction of the rear end of the screw, from the thread having the larger external diameter, which cuts more deeply into the wall of the drilled hole, to the next turn of the thread having the smaller screw diameter. As a result, the transfer of force from the concrete screw to the concrete is improved.

In a preferred embodiment, the ratio of the external diameter of the thread having the larger external diameter to the external diameter of the thread having the smaller external diameter is about from 1.03 to 1.14. The larger external diameter can be up to about 20% larger than the smaller external diameter. This diametric ratio of the external diameters of the two threads has been found to be advantageous for a high holding force of the concrete screw in the concrete.

In an embodiment of the invention, the ratio of the external diameter of the thread having the larger external diameter to the pitch of the threads of the concrete screw is about from 0.9 to 1.2, the pitch being the axial spacing of consecutive turns of one thread.

The ratio of the external diameter of the thread having the larger external diameter to the core diameter of the concrete screw is, in an embodiment of the invention, about from 1.2 to 1.4, preferably about from 1.25 to 1.35 and especially from 1.27 to 1.32. The latter ratio has been found to be especially advantageous for a high holding force of the concrete screw in the concrete with an acceptable screw-in torque. However, similarly good holding values and screw-in torques are feasible with the larger tolerance ranges.

The flank angle α of one or both threads of the concrete screw is, in an embodiment of the invention, about from 40° to 50°, it being possible for the threads to be V-shaped threads having the same flank angles on both sides of the threads. In an embodiment of the invention, a sawtooth thread is provided for one or both threads of the concrete screw, in which case preference is given to making the thread flank that faces the front end of the screw steeper and the thread flank that faces the rear end of the screw flatter. The front thread flank has an angle of, for example, about from 80° to 90° to the axial direction, that is to say it extends radially or at an angle of up to about 10° to a radial line. The flank angle between the two flanks of the particular thread remains unchanged between about 40° and 50° or is more obtuse. The more slanted position of the rear flank of the threads in the case of a sawtooth thread improves the transfer of force from the thread to the concrete.

Claim 8 is directed to the self-tapping concrete screw, in the above-mentioned embodiments, screwed into a hole drilled in concrete. In this case, in a preferred embodiment of the invention, the ratio of the pitch of the threads of the concrete screw to the diameter of the drilled hole is about from 1.01 to 1.45. The ratio of the external diameter of the thread having the smaller external diameter to the diameter of the drilled hole is, in an embodiment of the invention, about from 1.01 to 1.15 and the ratio of the core diameter of the concrete screw to the diameter of the drilled hole is, in an embodiment of the invention, about 0.95. These dimensioning rules, which can be put into practice singly or in any desired combination in embodiments of the invention, have been found to be advantageous with respect to the holding values of the concrete screw in concrete.

In a preferred embodiment of the invention, the ratio of the spacing of the threads from one another seen in the direction of the rear end of the concrete screw to the penetration depth of the particular thread in the wall of the drilled hole is about 8:1. The penetration depth is ½ the difference between the external diameter of the particular thread and the diameter of the drilled hole. Because the spacing of the threads from one another seen in the direction of the rear end of the concrete screw differs and, in particular, is smaller in the case of the thread having the smaller external diameter and larger in the case of the thread having the larger external diameter, the mentioned ratio of the spacing of the threads to the penetration depth can be put into practice at least approximately for both threads. The ratio is also dependent on the hardness of the concrete. This embodiment has been found to be advantageous for transfer of a high force from the threads to the concrete.

The invention will be explained in greater detail hereinbelow with reference to an example of an embodiment shown in the drawing. The single Figure shows a concrete screw according to the invention which has been screwed a short distance into a drilled hole. The drawing is not to scale.

The self-tapping concrete screw 1 (shown in the drawing) according to the invention is intended for screwing into a hole 2 drilled in concrete 3, masonry or the like. The concrete screw 1 is screwed into the drilled hole 2 without using a fixing plug or other aid.

The concrete screw 1 has a taper 4 in the shape of a truncated cone at the front end 5 and has a screw head 6 at the rear end 7. In the shown example of an embodiment, the screw head 6 is a hexagonal head but this shape of head is not mandatory.

The concrete screw 1 has two threads 8, 9 having external diameters of different size. The external diameter d₁ of the thread 8 having the smaller external diameter d₁ is larger than the diameter D of the drilled hole so that, when the concrete screw 1 is screwed into the drilled hole 2, both threads 8, 9 cut into the wall 10 of the drilled hole. The threads 8, 9 are not located in the middle between the turns of the respective other thread 8, 9. Seen from the front end 5 of the screw, the spacing Pi from the thread 8 having the smaller diameter d₁ to the thread 9 having the larger external diameter d₂ is smaller than the spacing P2 from the thread 9 having the larger external diameter d₂ to the thread 8 having the smaller external diameter d₁. The pitch p of the concrete screw 1 is the spacing from one turn of a thread 8, 9 to the following turn of the same thread 8, 9, that is to say it is the sum of the spacings p₁, p₂ of the threads 8, 9 from one another.

The threads 8, 9 can be in the form of V-shaped threads having a flank angle of, for example, about from 40° to 50° (not shown). In the shown and described example of an embodiment of the invention, the threads 8, 9 are in the form of sawtooth threads, a steeper flank 11, 12 of the threads 8, 9 facing the front end 5 of the screw and a flatter thread flank 13, 14 facing the rear end 7 of the screw. The front flank 11, 12 of the threads 8, 9 has an angle of about from 80° to 90° to the axial direction of the concrete screw 1; in the shown and described example of an embodiment, the angle is 80°, that is to say the front flank 11, 12 of the threads 8, 9 extends almost radially outwards from the concrete screw 1. The flank angle α between the two flanks 11, 13; 12, 14 of the threads 8, 9 is 60°, so that the rear flank 13, 14 of the threads 8, 9 extends at an angle of 40° to the axial direction of the concrete screw 1. The slanted position of the rear thread flanks 13, 14 of the threads 8, 9, which form a surface that is similar to a truncated cone and that winds around a thread core 15 of the concrete screw 1, is decisive or at any rate partly decisive for the holding force of the concrete screw 1 in the concrete 3.

The ratio of the external diameter d₂ of the thread 9 having the larger external diameter to the core diameter d_{K} of the thread core 15 is 1.3; the external diameter d₂ of the thread 9 having the larger external diameter d₂ is about 10-12% larger than the external diameter d₁ of the thread 8 having the smaller external diameter d₁.

The ratio of the external diameter d₂ of the thread 9 having the larger external diameter to the pitch p of the concrete screw is 1 or slightly more.

The ratio of the spacings p₁, p₂ of the threads 8, 9 from one another, specifically when seen from the front end 5 of the screw, to the penetration depth of the particular thread 8, 9 into the wall 10 of the drilled hole is about 8:1, the penetration depth being half the difference between the particular external diameter d₂, d₁ of the threads 8, 9 and the diameter D of the drilled hole (½ (d₂−D) or ½ (d₁−D)). Because the spacings p₁, p₂ of the threads 8, 9 from one another are of different size, the mentioned ratio can be maintained at least approximately for both threads 8, 9 despite the differing external diameters of the threads 8, 9. Because the thread 8 having the smaller external diameter d₁ has a smaller depth of penetration into the wall 10 of the drilled hole, the requisite supporting length in the axial direction to the next thread 9 for transferring a pull-out force from the concrete screw 1 to the concrete 3 is less than in the case of the thread 9 having the larger external diameter d₂. The mentioned ratio of 8:1 appears to give an optimum value for the transfer of force from the threads 8, 9 to the concrete 3 and therefore a high holding force of the concrete screw 1 in the concrete 3 or at any rate to be close to the optimum value.

The ratio of the pitch p of the threads 8, 9 of the concrete screw 1 to the diameter D of the drilled hole 2 is about 1.2; the ratio of the external diameter d₁ of the thread 8 having the smaller external diameter d₁ to the diameter D of the drilled hole 2 is about 1.1. The ratio of the diameter D_{K} of the thread core 15 of the concrete screw 1 to the diameter D of the drilled hole is about 0.95, so that an intermediate space is formed between the thread core 15 and the wall 10 of the drilled hole. This improves, or makes possible in the first place, the ability of the concrete screw 1 to be screwed into the drilled hole 2. Drilling dust from the drilling of the hole 2 and from the cutting of the threads 8, 9 into the wall 10 of the drilled hole can collect in the intermediate space when the concrete screw 1 is being screwed in.

1. Self-tapping concrete screw for screwing into a hole drilled in concrete, characterised in that the concrete screw (1) has two threads (8, 9), in that the threads (8, 9) have different external diameters (d₁, d₂), and in that the spacing (p₁, p₂) of the threads (8, 9) from one another differs in the two directions along the axis of the concrete screw (1).

2. Concrete screw according to claim 1, characterised in that the spacing of the thread (8) having the smaller external diameter (d₁) from the thread (9) having the larger external diameter (d₂) in the direction of the front end (5) of the concrete screw (1) is greater than in the direction of the rear end (6) of the concrete screw (1).

3. Concrete screw according to claim 1, characterised in that the external diameter (d₂) of the thread (9) having the larger external diameter is up to about 20% larger than the external diameter (d₁) of the thread (8) having the smaller external diameter.

4. Concrete screw according to claim 1, characterised in that the ratio of the external diameter (d₂) of the thread (9) having the larger external diameter to the pitch (p) is about from 0.9 to 1.2.

5. Concrete screw according to claim 1, characterised in that the ratio of the external diameter (d₂) of the thread (9) having the larger external diameter to the core diameter (d_{K}) of the concrete screw (1) is about from 1.2 to 1.4.

6. Concrete screw according to claim 1, characterised in that a thread (8, 9) of the concrete screw (1) has a flank angle (α) of about from 40° to 60°.

7. Concrete screw according to claim 1, characterised in that a thread (8, 9) of the concrete screw (1) is a sawtooth thread.

8. Self-tapping concrete screw (1) screwed into a hole (2) drilled in concrete (3), characterised in that the concrete screw (1) has two threads (8, 9), in that the threads (8, 9) have different external diameters (d₁, d₂), and in that the spacing (p₁, p₂) of the threads (8, 9) from one another differs in the two directions along the axis of the concrete screw (1).

9. Self-tapping concrete screw screwed into a hole (2) drilled in concrete (3), in accordance with claim 8, characterised in that the ratio of the spacing (p₁, p₂) Of the threads (8, 9) from one another seen in the direction of the rear end (6) of the concrete screw (1) to the penetration depth of the thread (8, 9) in the wall (10) of the drilled hole is about 8:1.

10. Self-tapping concrete screw (1) screwed into a hole (2) drilled in concrete (3), in accordance with claim 8, characterised in that the ratio of the pitch (p) of the threads (8, 9) of the concrete screw (1) to the diameter (D) of the drilled hole is about from 1.01 to 1.45.

11. Self-tapping concrete screw (1) screwed into a hole (2) drilled in concrete (3), in accordance with claim 8, characterised in that the ratio of the external diameter (d₁) of the thread (8) having the smaller external diameter to the diameter (D) of the drilled hole is about from 1.01 to 1.15.

12. Self-tapping concrete screw (1) screwed into a hole (2) drilled in concrete (3), in accordance with claim 8, characterised in that the ratio of the core diameter (d_{K}) of the concrete screw (1) to the diameter (D) of the drilled hole is about 0.95.
